(19) United States
(12) Patent Application Publication
(10) Pub. No.: US 2002/0029330 A1
(43) Pub. Date: Mar. 7, 2002

(54) Data processing system

(76) Inventors: Shoichi Kamano, Tokyo (JP); Yoshihide Sugiura, Tokyo (JP)

Correspondence Address: William C. Rowland, BURNS, DOANE, SWECKER & MATHIS, L.L.P., P.O. Box 1404, Alexandria, VA, 22313-1404, US

(21) Appl. No.: 09/933,819

(22) Filed: Aug. 22, 2001

(30) Foreign Application Priority Data
Aug. 29, 2000 (JP) 2000-259816

(51) Int. Cl. G06F 15/00

(52) U.S. Cl. 712/34

(57) ABSTRACT

A data processing system of the invention comprises a special purpose data processing unit for executing a series of predetermined data processings by a special purpose instruction and a general purpose data processing unit for executing processings designated by general purpose instructions. The special purpose data processing unit has a dedicated circuit portion specialized in specific data processings and a sequence control portion that supplies the dedicated circuit portion with control signals to control the dedicated circuit portion in accordance with a predetermined processing procedure. In addition, the general purpose data processing unit can control the dedicated circuit portion in accordance with a procedure different from the processing procedure preset in the sequence control portion. Thus, it is possible to provide the data processing system that can flexibly deal with even such alterations as have an influence on the specification of the special purpose data processing unit.

### BACKGROUND OF THE INVENTION

1. Technical Field

The present invention relates to a data processing system including a dedicated circuit.

2. Description of the Related Art

It is no exaggeration to say that nothing can withstand recent improvement in the speed and capacity of the network as well as diversification of applications requiring a real-time operation or processing. Such a real-time operation or processing is also required for a processor upon executing an application such as image processing, and particularly, data compression and decompression. As a result, processors for use in high-speed personal computers and game machines operate at an extremely high clock frequency so as to have the ability to process a plurality of applications at a high speed. However, these processors have general-purpose features and therefore cannot deal with all the requirements for real-time processing.

In contrast, a dedicated or special purpose circuit that is specialized in a specific processing using the hard-wired logic or the like is designed to be capable of real-time response if such a real time response is required. Accordingly, in the field of applications for which the real-time response is highly required and even a one-clock delay in the data processing would make the processors unpractical, the response must be ensured by the dedicated circuits.

Thus, the fields of communication, network and image processings appreciably require that such dedicated circuits be employed to constitute control devices. However, the business world of applications of this type makes much account of standard specification, without which it would be impossible to find entry into the market. For this reason, every company has been striving to have a say in determining the specification. To win a leading share in the market, it is necessary to commercialize an appropriate system immediately after determination of the specification and put the system on the market. Thus, it has been required to reduce the period for designing, especially the period for designing a system LSI and to demonstrate flexibility in dealing with post-alterations in specification.

However, the dedicated circuit requires a long time for its designing and verification and practically lacks flexibility in dealing with alterations in specification. Therefore, although the dedicated circuit is desirable from the standpoint of performance, it would not be advisable to count on the dedicated circuit if the circumstances where the system LSI is designed and developed are taken into account. However, as described above, general-purpose processors are often insufficient in real-time response performance.

A data processing system or device having a general purpose data processing unit (PU) capable of general-purpose processing on the scale that is equal to or smaller than that of the above general-purpose processor, and a special purpose data processing unit (VU) that is dedicated for special purpose and specialized in a specific data processing, is proposed. In this data processor, a special purpose or special purpose instruction for operating the VU is included in a program of the data processor, as well as a general purpose instruction, therefore, the VU is called by the program for processing the process a real-time response is required. Accordingly, the specification of the data processor is changed by the program level or by the processing of the PU.

Furthermore, a basic architecture composed of a fetch unit (FU) for fetching a program, a decoder, the PU with a basic set of instructions, and so on is prepared. Contrary, the VU to be operated by the architecture can be selected or developed depending on the type of each application to be performed. Thus, it is possible to reduce the period for designing and development. It is also possible to introduce a dedicated circuit that has proved reliable as the VU. Therefore, it is possible to develop a system that can handle applications requiring real-time performance within a short period of time, and to deal with post-alterations in design flexibly.

As described hitherto, the architecture employing the general purpose data processing unit (PU) and the special purpose data processing unit (VU) makes it possible to develop a system suited for applications requiring real-time response performance within a short period of time and to flexibly deal with post-alterations on a program level. However, if the scope of alterations in specification extends to the VU, i.e. to the contents of processings to be executed by special purpose instructions, it is impossible to find a solution on a program level. Thus, it is necessary to redesign the VU.

Conventionally, it is quite normal to determine the specification of the VU at an early stage, since the VU is mainly designed to execute the certain data path processings. However, there is always a possibility that alterations in specification that have an influence on the construction of the VU might take place for some reason. If such alterations in specification cannot be dealt with properly, users may feel discontented with the performance of the system LSI or there is a possibility of applications using the system LSI being restricted functionally.

It is thus an object of the invention to provide a data processing system that can flexibly deal with even such alterations as have an influence on the specification of the VU. It is also an object of the invention to provide a data processing system that can flexibly deal with alterations in specification at any stage of development and that can make the most of the function of the VU. It is also an object to provide a method of controlling such a device, and a program for controlling such a device.

### SUMMARY OF THE INVENTION

According to the present invention, a dedicated circuit of a VU is controlled by a PU for performing a process different from a predetermined processing procedure preset in the VU. That is, a data processing system of the invention comprises at least one special purpose data processing unit (VU) for executing a series of predetermined data processes by a special purpose instruction (V-instruction) and a general purpose data processing unit (PU) for executing processes designated by general purpose instructions (P-instruction) according to the order of the general purpose instructions sequentially. The special purpose data processing unit has a dedicated circuit portion specialized in specific data processings and a sequence control portion that supplies the dedicated circuit portion with control signals to control the dedicated circuit portion in accordance with a predetermined processing procedure. The general purpose data processing unit is able to control the dedicated circuit portion in accordance with a procedure different from the processing procedure preset in the sequence control portion.

In the data processing system of the invention, the dedicated circuit portion of the special purpose data processing unit can be operated by the general purpose data processing unit in accordance with a processing procedure different from the original processing procedure. Namely, in a control method of this data processing system, in addition to a first step of supplying the dedicated circuit portion with a series of control signals by the special purpose instruction in accordance with the processing procedure preset in the sequence control portion for controlling the dedicated circuit portion, a second step of controlling the dedicated circuit portion by at least one of the general purpose instructions in accordance with the other procedure different from the processing procedure preset in the sequence control portion can be provided.

Accordingly, operation of the dedicated circuit portion of the special purpose data processing unit that is fixed with the processing procedure according to the special purpose instructions becomes controllable or changeable on a program level. Therefore, it is possible to highly flexibly deal with even such alterations or modifications in specification that have occurred after a stage of development, designing or manufacture. Thus, the data processing system of the invention makes it possible to process and control a single control object, i.e. the dedicated circuit portion at a high speed by means of hardware control, and also by means of the software flexibly.

Namely, in a program product for controlling this data processing system, in addition to the special purpose instruction to supply the dedicated circuit portion with the control signals in accordance with the preset processing procedure in the sequence control portion, a priority instruction to control the dedicated circuit portion in accordance with a procedure different from a processing procedure preset in the sequence control portion can be provided as the general purpose instructions. The program product for control is provided storing in a recording medium such as ROM, readable by a computer, i.e. a data control system, device or processor. The ROM or RAM can be included in the data processing system. Further, the control program product can also be provided as a program embedded in a transmission medium transmitted through a communication system among computers, e.g. internet.

In the data processing system comprising a fetch unit for fetching the special purpose instruction and the general purpose instructions from the program recorded and for supplying the special purpose data processing unit with the special purpose instruction, it is possible to provide a meaning or an environment suited for real-time processings by operating the dedicated circuit portion at a high speed by the special purpose instruction. Also, the dedicated circuit portion can be operated in accordance with another processing procedure different from the preset processing procedure by the general purpose data processing unit controlled by the general purpose instructions. Thus, by the same data processing system, it is also possible to provide a meaning or an environment in which processings of the dedicated circuit portion is executed flexibly using program.

It is possible to provide the general purpose data processing unit that is able to supply the dedicated circuit portion with control signals (second control signals) superseding the control signals (first control signals) supplied from the sequence control portion, and the special purpose data processing unit having a selection means for supplying the dedicated circuit portion with selected controls among the first control signals supplied from the sequence control portion and the second control signals supplied from the general purpose data processing unit. In the data processing system having such general purpose data processing unit and special purpose data processing unit, it becomes possible to control the dedicated circuit portion by means of the general purpose data processing unit in accordance with a desired procedure, that is, a processing procedure different from the processing procedure set in the sequencer control portion in advance. By controlling the selection means by the general purpose processing unit, it becomes possible to perform program-based control on the side of the general purpose processing unit so as to determine whether the dedicated circuit portion is to be operated by the special purpose instruction or under control of the general purpose processing unit.

Therefore, it is desirable that the general purpose data processing unit be able to supply the dedicated circuit portion with the control signals superseding the control signal of the sequence control portion based on at least one of the general purpose instructions, and that the special purpose data processing unit have the selection means for supplying the dedicated circuit portion with the selected control signals. In the second step of the control method of this data processing system, the dedicated circuit portion is supplied with the control signals superseding the control signal of the sequence control portion based on at least one of the general purpose instructions. For this purpose, it is desirable to prepare the control program for the data processing system that has as the priority instruction to be converted into the second control signals for supplying to the dedicated circuit portion and for superseding the first control signal of the sequence control portion.

Above method is suited for a case where a hardware sequence control method using the hardware sequencer is adopted to control the dedicated circuit portion that is composed of data paths such as a register file, an arithmetic circuit, a shifter and so on for executing specific data processings. The hardware sequencer has a state in a state-register and outputs the control signal in accordance with the state. Thus, the hardware sequencer has merits such as a high operating speed and a small occupied area and can make the system LSI compact. In the hardware sequencer, transition of the state is determined from a current state and an input signal by a combinational circuit. Since the hardware sequencer has a finite state, it is also referred to as an FSM (Finite State Machine).

According to the present invention, the control signals are outputted to the dedicated circuit portion from the general purpose data unit PU, it becomes possible to flexibly control the dedicated circuit portion without modifying the hardware of the hardware sequencer, and to flexibly deal with alterations in specification without modifying the hardware sequencer. Further, it is preferable to having a mode register in the selection means for being controlled from the PU. The mode register offers a merit of enhanced flexibility of the dedicated processing in the special purpose data processing unit. That is, the dedicated circuit portion, which is the data path portion, becomes finely controllable by the software via the general purpose instruction.

In order to control the dedicated circuit portion in accordance with a processing procedure different from the predetermined processing procedure, it is also possible to alter the processing procedure set in the sequence control portion by means of the general purpose data processing unit. Thus, it is desirable that the general purpose data processing unit be able to alter the processing procedure set in the sequence control portion by means of a general purpose instruction. In the second step of the control method of this data processing system, the processing procedure itself, which is preset in the sequence control portion, is altered by the general purpose instruction. For this purpose, it is desirable that an instruction to alter the processing procedure preset in the sequence control portion be provided as the priority instruction.

This method is effective in the case that the sequence control portion has an SRAM or the like for software sequence controlling and act as a software sequencer in which a program for controlling the dedicated circuit portion is stored. By rewriting the contents of the program recorded in the SRAM, it becomes possible to change the combination of instructions for the dedicated circuit portion and alter the processing procedure in the special purpose data processing unit. In general, adoption of a software sequencer tends to bring about an increase in occupied area and an increase in size of the system LSI as a data processing device. On the other hand, however, such a software sequencer offers freedom in resetting the contents of sequence. Thus, the software sequencer offers a merit of further enhanced flexibility of the processing contents of the special purpose data processing unit. Further, it is also possible to provide the data processing system that has the special purpose data processing unit including the software sequencer so that the control program can be rewritten and the general data processing unit which can control the dedicated circuit portion in the aforementioned method.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 schematically shows a system LSI having a VU and a PU.

FIG. 2 schematically shows a system LSI according to the invention.

FIG. 3 schematically shows a control system of a dedicated circuit of the VU shown in FIG. 2.

FIG. 4 shows minute details of an example of the VU shown in FIG. 2.

FIG. 5 shows an exemplary control program of the system LSI shown in FIG. 2.

FIG. 6 shows a transition state of an FSM of the VU.

FIG. 7 shows control signals outputted from the FSM.

FIG. 8 shows control signals outputted as decoded P-instructions.

FIG. 9 shows a control list indicating a procedure different from a procedure set in the VU.

FIG. 10 shows an exemplary program for performing processings of the control list shown in FIG. 9 by means of P-instructions.

FIG. 11 shows the construction of a system LSI of the invention which is different from the aforementioned one.

FIG. 12 shows the construction of sequence control of the VU.

### DESCRIPTION OF THE PREFERRED EMBODIMENTS

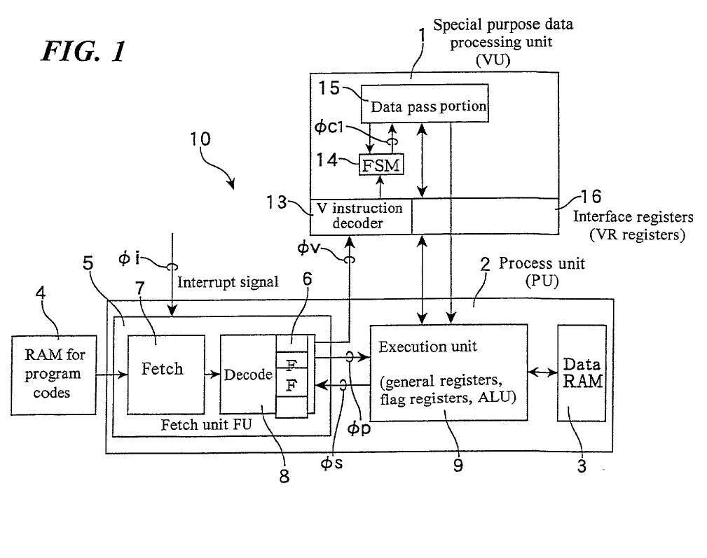

Hereinafter, the invention will be described in more detail with reference to the drawings. FIG. 1 schematically shows the construction of a data processing system. The data processing system is a system LSI 10 having a special purpose data processing unit 1 and a general purpose data processing unit 2. The special purpose data processing unit 1 is called also a special purpose instruction execution unit or dedicated data processing unit and hereinafter referred to as VU that is specialized in performing specific processings. The general purpose data processing unit 2 is called also general-purpose instruction execution unit or process unit and hereinafter referred to as PU that has a general processor's construction. In the system LSI 10, processings in the VU 1 are fixed. The processor PU 2 installed in this LSI is provided with a fetch unit 5 that fetches instructions from a code RAM 4 with a built-in program code of an execution form (micro program code). The fetch unit 5 has a fetch portion 7 that fetches the instruction from a certain address of the code RAM 4 which is determined by the preceding instruction or the state of a state register 6, an interrupt signal φi and so on, and a decoding circuit 8 that decodes a fetched special purpose instruction (V-instruction) and general-purpose instruction (general instruction, P-instruction) and that supplies the VU 1 or an execution unit 9 of PU 2 with decoded control signals φv as the decoded special purpose instructions or decoded control signals φp as the decoded general-purpose instructions. Furthermore, a status signal indicating an execution state is returned from the execution unit 9 of the PU 2 so that states of the PU 2 and the VU1 are reflected on the state register 6.

The PU 2 also includes the execution unit (EU) 9 that has a high degree of general-purpose applicability and be composed of a general-purpose register, a flag register, an arithmetic unit (ALU) and so on, and a data RAM 3 that serves as a temporary memory area when the execution unit 9 executes processings. Since the general purpose data processing unit PU 2 has an FU 5 and the execution unit 9, it may be possible to recognize that the PU5 has the construction substantially the same as conventional standard processors.

The special purpose data processing unit VU 1 for executing a special purpose instruction φv supplied from the PU 2 has a decoding unit 13 that determines whether the supplied instruction is a V-instruction φv and whether the V-instruction is an instruction to activate the VU1 itself in the case where a plurality of VU's are installed in the LSI 10, an FSM (Finite State Machine) 14 that is the hardware for outputting control signals being set in advance for execution of a specific data processing, a dedicated circuit (data path) portion 15 that is designed to execute a specific data processing in accordance with the control signals from the FSM 14, and an interface register 16 that functions as an interface with the PU 2. Thus, the PU 2 can refer an internal state of the VU 1 via the interface register 16. Further, a result processed in the data path portion 15 is supplied to the PU 2, and the PU 2 executes processings using the result. The FSM 14 acts as a hardware sequencer for activating the function of the dedicated circuit portion 15, and outputs control signals in accordance with a state in a register as the finite state machine. Transition of the state is determined by a combinational circuit based on a current state and an input signal. Thus, upon supply of a V-instruction φv, the FSM 14 sequentially supplies the dedicated circuit portion 15 with the control signals φc1 according to a preset sequence and the transition of the state for executing predetermined data processings in the dedicated circuit portion 15.

In the system LSI 10 shown in FIG. 1, a program including the general purpose instructions (P-instructions) and the special purpose instructions (V-instructions) is stored in the code RAM 4. The general purpose instruction and the special purpose instruction are fetched by the fetch unit 5 and outputted as a decoded control signals φp and φv. Using the decoding unit 13, the VU1 discriminates the control signal φv corresponding to the special purpose instruction for activating the VU 1 among the control signals φp and φv. The VU 1 is operated as soon as the control signal φv is supplied thereto.

On the other hand, in the PU 2, only the control signals φp corresponding to the general purpose instructions are supplied. The control signals decoded the V-instruction are not issued in the PU 2 to the execution unit 9. Instead, a control signal indicating an nop-instruction of no-execution is issued, and processings in the PU 2 are skipped. Because the nop-instruction is issued instead of the control signal corresponding to the V-instruction, the PU 2 is not required to deal with the V-instruction or the control signal obtained by decoding it. That is, the VU 1 is changed depending on application and so on. In many cases, the special purpose instruction for the VU 1 also changes depending on applications. The VU 1 is the dedicated processing unit specialized in the certain application and being designed to interpret the control signal obtained by decoding the V-instruction of that application. On the other hand, since the nop-instruction is outputted to the PU 2, the PU 2 is not required to deal with the V-instruction specialized in the VU 1 but is required only to interpret and execute basic general purpose instructions. Thus, the PU 2 is compatible with the VU's 1 for various kinds of applications without sacrificing general-purpose applicability or feature for controlling VU's and for executing processes using arithmetic results obtained from VU's.

Thus, the system LSI 10 has the dedicated unit VU 1 capable of realizing real-time response and the processor PU 2 that has a high degree of general-purpose applicability. The PU 2 is almost the same as a general-purpose installation-type processor that sequentially reads and executes P-instructions according to a program counter, thus the construction of the processor and the program that have turned out to be reliable are utilized for designing the PU 2. Accordingly, the system LSI 10 having the VU 1 and the PU 2 of this embodiment can execute processes requiring a high processing speed and/or real-time performance by means of the VU 1, and processes requiring general-purpose feature such as error processings by means of the PU 2.

Furthermore, control of the VU 1 is also defined on the program, therefore, it is possible to reduce the periods for designing and development of the LSI 10. In addition, the LSI 10 flexibly deals with subsequent alterations or modifications. At the same time, the system LSI also deals with processings requiring high process-ability and clock-based control, such as real-time processings that cannot be realized by a conventional program based device. Further, the VU 1 is not limited one per LSI, a plurality of VU's 1 are installed depending on the application to be performed in the LSI 10. In such a LSI 10, a plurality of special purpose instructions to activate the VU's 1 respectively are included in a program code to be stored in the Code RAM 4. Therefore, this architecture of processor VUPU is widely applicable.

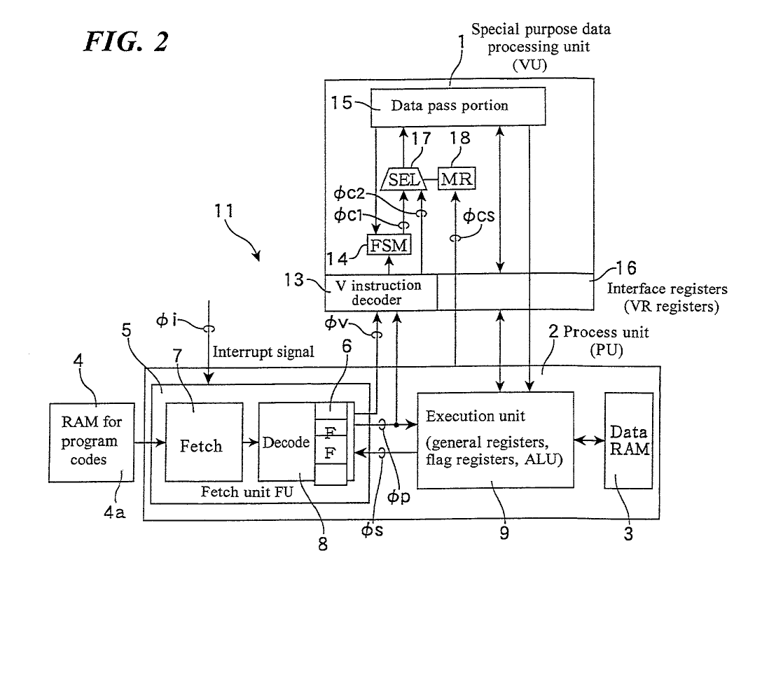

FIG. 2 shows a system LSI that is a data processing system of an embodiment of the present invention. The system LSI 11 of this embodiment also has the PU 2 and the VU 1. Therefore, the common components are denoted by the same reference symbols and the description thereof will be omitted. The LSI 11 is controlled by the program 4a stored in the code RAM 4. As explained, the program code 4a is composed of special purpose instructions (V-instructions) and general-purpose instructions (P-instructions). The VU 1 is supplied with signals φv obtained by decoding the V-instructions. In the system LSI 11, the VU 1 is supplied with a part of P-instructions φp as well as the V-instructions. The decoding unit 13 of the VU 1 has the functions of decoding the supplied P-instructions φp into control signals (second control signals) φc2 that are substituted for the control signals (first control signals) φc1 supplied from the FSM 14, and outputting the control signals φc2. The VU 1 of this example has a selector 17 capable of selecting the control signals φc1 supplied from the FSM 14 or the control signals φc2 obtained by decoding the P-instructions φp supplied from the PU 2. Therefore, from the selector 17, the selected control signals are supplied to the data path portion 15 that is the dedicated circuit portion. A mode register (hereinafter referred to as the MR) 18 indicating which one of the control signals φc1 and φc2 is to be selected by the selector 17 is provided. The value of the MR 18 is set by signal φcs from the execution unit 9 of the PU 2.

Thus, in the system LSI 11, the data path portion 15 of the VU 1 is controlled by the control signals φc1 from the FSM 14 according to the sequence preset in the FSM 14 in the same manner as the aforementioned system LSI 10, and is also controlled by the control signals φc2 corresponding to the instructions from the PU 2 by changing the value of the MR 18. Thus, the data path portion 15 can be operated in accordance with the series of processing procedures preset in the FSM 14. Also, the data path portion 15 can be operated by the program 4a stored in the RAM 4 via the FU 5 of the PU 2 in accordance with a processing procedure different from that of the FSM 14. Therefore, the data path portion 15 executes preset data processes when the real-time basis operation is required by the hardware sequence control method. On the other hand, if the data path portion 15 is required to execute other processes, the data path portion 15 executes the processes according to the program 4a flexibly. Thus, if the necessity of executing different types of processings in the data path portion 15 after manufacture arises, the LSI 11 can flexibly deal with the necessity by rewriting the program 4a stored in the code RAM 4.

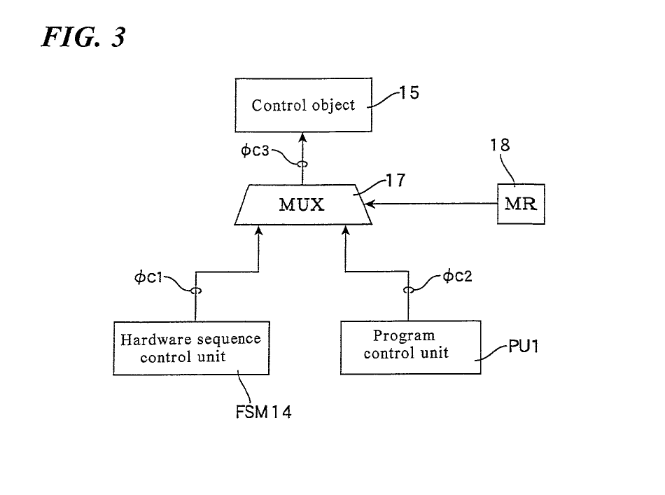

According to the system LSI 11 of this embodiment, as shown in FIG. 3, the FSM 14 that is the hardware sequence control device and the PU 2 that is the program control device are prepared to control the data path portion 15 that is the control object. In this embodiment, the control object, namely the data path portion 15 is the dedicated circuit of the VU 1 for executing data processes using register files, arithmetic circuits, shifters and so on. The control signals φc1 from the FSM 14 as the hardware sequence control device or the control signals φc2 outputted based on the instructions from the PU 2 that is the program control device is selected by the selection circuit 17 based on the value set in the MR 18. The selected control signals are outputted as the control signals φc3 for the data path portion 15 as the control object.

Thus, in the system LSI 11, the dedicated data path portion 15 can be controlled both in a hardware sequence control mode and in a program control mode. In the hardware sequence control mode, as described above, the control signal is outputted according to the state in the register and the transition thereof is determined by the combinational circuit based on a current state and an input signal supplied thereto. Such a machine is the FSM (Finite State Machine) because the transition of the state is limited or finite. On the other hand, in the program control mode, program codes are given from outside during that control mode. The program code or codes are held in a stack area such as RAM and converted into the control signals by a decoding circuit for outputting.

In the hardware sequence control mode, since a subsequent state is determined by the combinational circuit based on the current state and the input signal, a plurality of control signals are controlled at a high speed. However, transition of the state is fixedly determined by the combinational circuit. Therefore, once an LSI (ASCI) for a specific purpose has been shaped into a hardware, control thereof cannot be altered easily.

On the other hand, in the case where program control is performed, the program control device is usually designed such that its program codes can be changed afterwards. For this reason, even after the control device has been shaped into a hardware as a product such as an ASIC, control thereof can be altered easily. However, since program control is performed in separate steps of general-purpose program code, it is generally performed at a lower speed in comparison with the hardware sequence control mode.

Accordingly, if the data path using the register files, the arithmetic circuits and so on has been prepared for the purpose of executing a certain processing where required performance cannot be met by program control, the introduction of hardware sequence control is inevitable to increase the speed of control. However, if hardware sequence control is introduced, processings other than those determined by hardware sequence control cannot be executed. Namely, once a hardware such as an ASIC has been employed, it is impossible to alter the processings using the data path subjected to hardware sequence control or cause the data path to execute other processings. Thus, since speeding up is guaranteed despite a decline in flexibility, the aforementioned system LSI 10 is also equipped with one or a plurality of VU's 1 that are operated by a V-instruction φv so as to provide an ASCI capable of real-time processings. On the other hand, the general-purpose PU 2 executes general-purpose processes, which are likely to be altered.

In the system LSI 11 of this embodiment, the architecture VUPU always has the PU 2 with the VU 1, and the PU 2 has the general feature that is able to become the program control device for controlling the data path portion 15 in VU 1. Therefore, the PU 2 is designed to acts the program control device for the data path portion 15 by the alterable and flexible processes. Also, in the LSI 11, the control signals outputted from the respective control devices are inputted to the selection circuit 17 for selecting one of the control signals. Therefore, it becomes possible to control the data path portion 15 either by hardware sequence control or by program control. Thus, in the system LSI 11, while remaining ability of predetermined processings in VU 1 being executed at a high speed by the hardware sequence control, the processings in VU 1 becomes changeable by introducing program control for performing other processes flexibly.

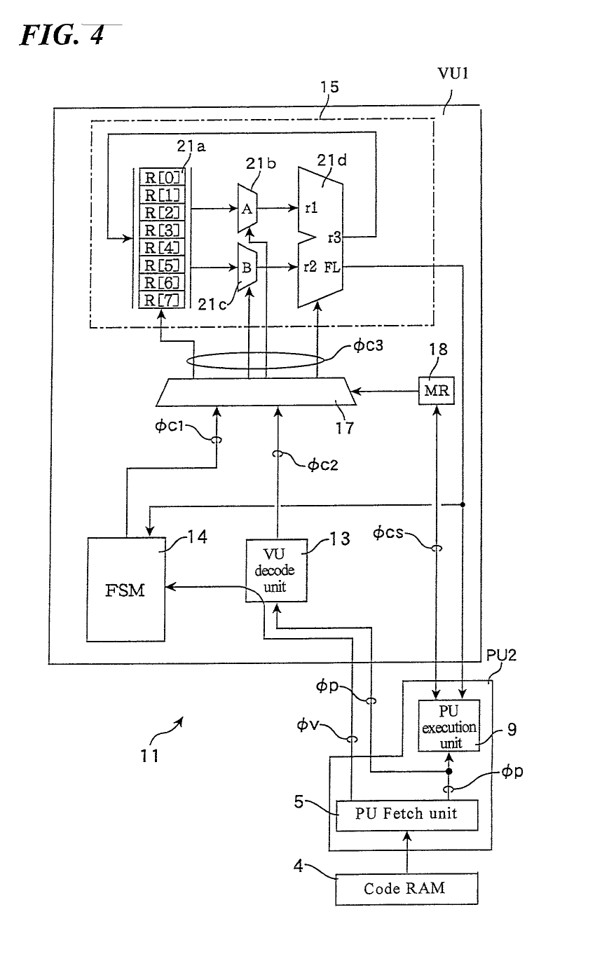

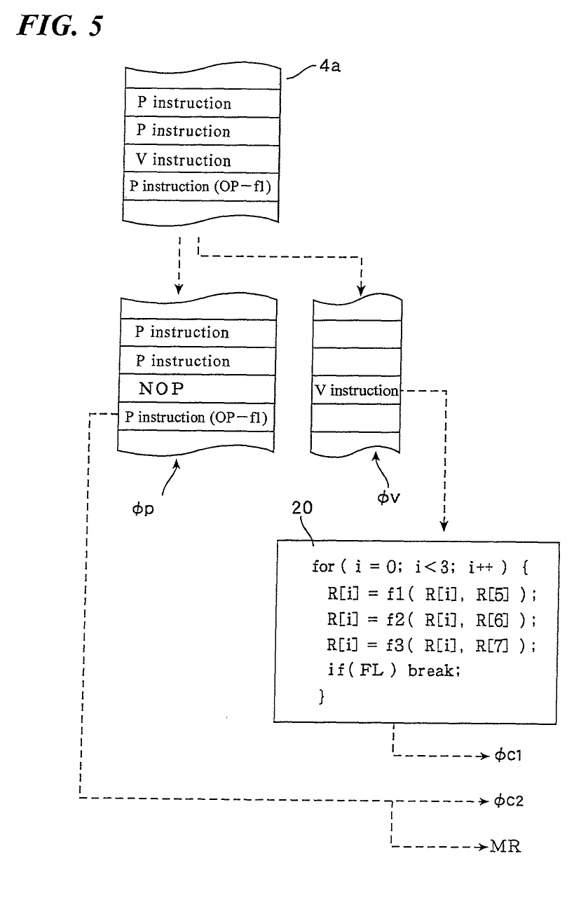

FIG. 4 shows a more detail example of the VU 1. The VU 1 is provided with the data path portion 15 for processing the processes in a list 20 shown in FIG. 5. The processes in the list 20 include performing calculation of f1 using R(i) and R(5) and storing the result into R(i), performing calculation of f2 using R(6) and the previous result in R(i) and storing the calculation result into R(i), performing calculation of f3 using R(7) and the previous result in R(i) and storing the result into R(i). These processings are executed according to a sequence of i=0, 1 and 2. It is to be noted, however, that the processings are terminated as soon as a flag FL occurs during calculation of f3.

In order to execute the processes by V-instructions in the LSI 11, the V-instruction instructing to execute that processes in the VU 1 is written into the program 4a stored in the code RAM 4 together with the P-instructions. As shown in FIG. 5, the FU 5 of the PU 2 sequentially fetches instructions of the program 4a, and the decoded P-instructions φp is supplied to the execution unit 9 corresponding to the fetched P-instructions. The decoded V-instruction φv corresponding to the fetched V-instruction is supplied to the VU 1, and the nop-instruction is supplied to the execution unit 9 correspondingly. Upon receiving the V-instruction φv, the VU 1 executes the processes in accordance with the processing procedure conforming to the processing list 20 set in the FSM 14.

As shown in FIG. 4, The data path portion 15 for executing the processing list 20 has a register file 21a, a register file readout selection circuit 21b and 21c, and an arithmetic circuit 21d. A flag signal FL is fed back to the FSM 14 from the arithmetic circuit 21d as a signal indicating termination of the processings. The register file 21a can hold eight kinds of data R(0) to R(7) and has two readout ports. One of the data R(0) to R(7) can be independently selected and outputted by the register file readout selection circuit 21b and 21c. An output from the arithmetic circuit 21d can be written into one of the data R(0) to R(7) via one port. Further, the arithmetic circuit 21d can execute a plurality of arithmetic processings by means of the control signal φc3. The arithmetic circuit 21d executes arithmetic processes using outputs from the register file readout selection circuit 21b and 21c as arguments, and outputs the arithmetic result. At the same time, the arithmetic circuit 21d outputs the flag signal FL accompanying the arithmetic result.

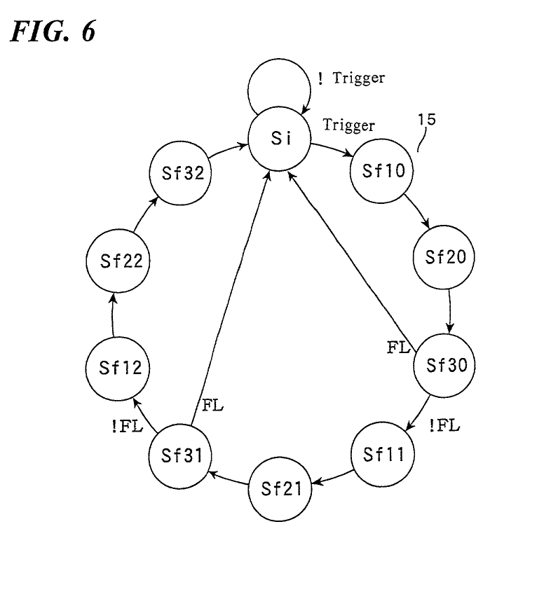

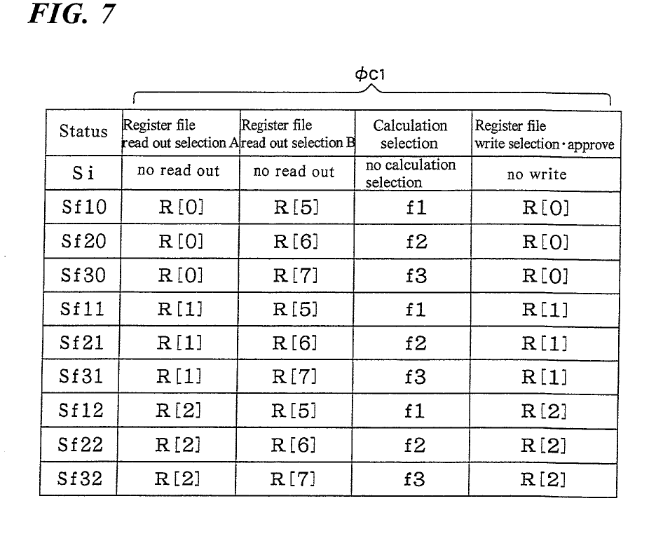

In order to operate the process in the data path 15, 4 control signals φc3 are required. One signal is that for controlling the register file readout selection circuit 21b. Another signal is that for controlling the register file readout selection circuit 21c. Another control signal is that for controlling arithmetic selection of the arithmetic circuit 21d, and the last signal is that for controlling selection and permission of the writing into the register file. The hardware sequence control device (FSM) 14 prepared to control the data path portion 15 supplies the group of hardware sequence control signals φc1. In order to execute the processes on the processing list 20 shown in FIG. 5, the FSM 14 may have states shown in FIG. 6 and output control signals φc1 corresponding to the states shown in FIG. 7.

In the system LSI 11, as briefly mentioned in the above, the data path portion 15 can further be controlled by P-instructions φp. Some of the P-instructions φp supplied from the PU 2 are decoded by the VU decoding unit 13 so that the control signals φc2 are supplied to the selector 17. Therefore, the control signals φc2 are selected at the selector 17, the data path portion 15 is controlled by the program 4a. Accordingly, the LSI 11 of this embodiment has a feature of a customizable LSI to which a user can add another function using the same data path portion 15 by the program.

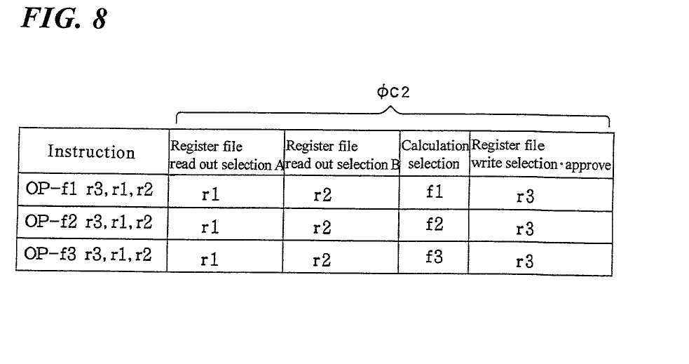

In this example, priority instructions OP-f1, OP-f2 and OP-f3 are prepared as P-instructions capable of controlling the data path portion 15. The VU decoding unit 13 is designed for decode the priority instructions and output the control signals φc2 as shown in FIG. 8. Thus, as shown in FIG. 5, if some of the P-instructions in the program 4a are the priority instruction OP-f1, the VU decoding unit 13 decodes the priority instruction into the control instruction φc2 and supplies the data path portion 15. At the same time, the priority instruction OP-f1 is also supplied to the PU execution unit 9. The MR 18 is set such that the selector 17 selects the control signal φc2 supplied from the PU 2. Thus, the data path portion 15 is controlled by the control signal φc2 that corresponds to the priority instruction OP-f1.

In this embodiment, the hardware sequence control signals φc1 and the program control signals φc2 are inputted to and selected by the selection circuit 17, and outputted as the data path control signals φc3 from the selection circuit 17 depending on the contents of the mode register (MR) 18. The PU 2 writes the content of the MR 18, therefore, the PU 2 can select either the FSM 14 or the PU 2 as a control device. Accordingly, the system LSI 11 is operable by the control method that has the first step of controlling the data path portion 15, that is the dedicated circuit of the VU 1, by means of the series of control signals φc1 supplied from the FSM 14 in response to V-instructions φv, and the second step of performing control in accordance with another processing procedure different from the procedure set in the FSM 14 by means of the control signals φc2 that supersede the control signals φc1 and that are obtained by decoding P-instructions φp whose fetch-timing is controlled by the PU 2.

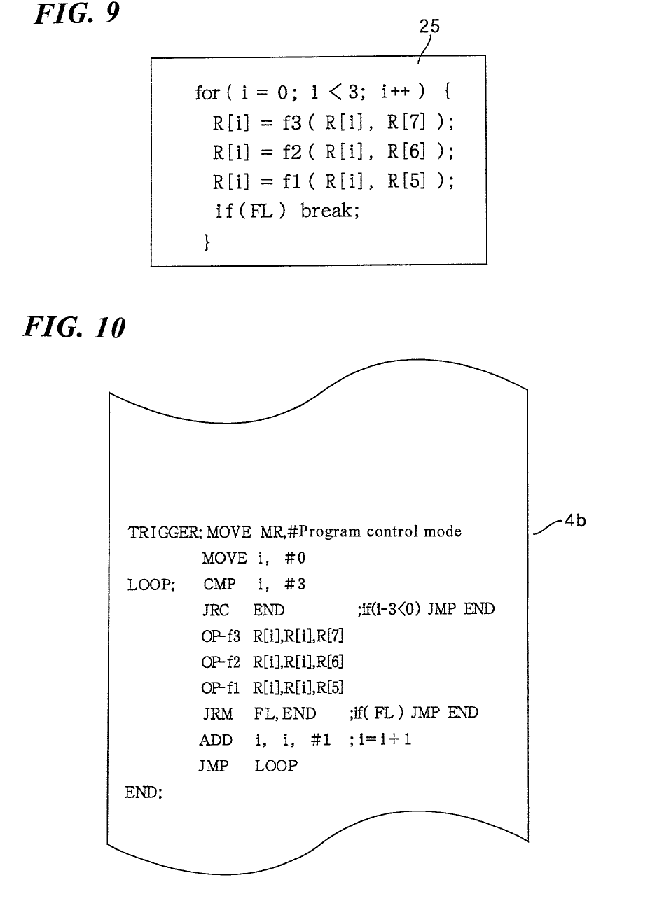

It is assumed in the system LSI 11 that the arithmetic processings executed by the data path circuit 15 of the VU 1 as indicated by the processing list 20 should be changed in order as indicated by a processing list 25 shown in FIG. 9. The FSM 14 of the VU 1 cannot execute the different order of processes as shown in the list 25. In the LSI 11, however, the data path portion 15 of the VU 1 can be controlled by P-instructions. Thus, a program 4b having priority instructions OP-f1, OP-f2 and OP-f3 as shown in FIG. 10 is prepared and executed by the PU 2. In this case, the MR 18 is set by the program 4b to select the control signals φc2 obtained by decoding the programmed priority instructions, whereby control of the data path portion 15 is switched from the FSM 14 to the PU 2. Thus, the program 4b shown in FIG. 10 makes it possible to control the data path portion 15 in accordance with the processing procedure 25 that is different from the processing procedure 20 set in the FSM 14.

The invention makes it possible to execute desired processings at a high speed by means of the hardware sequence control. If alterations are to be made to the processings, the same data path portion 15 can be utilized by switching data path control over to the program control. Thus, the processings can be altered easily.

In this example, PU 2 set the mode register 18 that generates the selection signal of the control selection circuit 17. However, the selection signal may also be supplied from the FSM 14 or be supplied from a processing block other than the VU 1 or the PU 2 or from a component outside the system LSI 11.

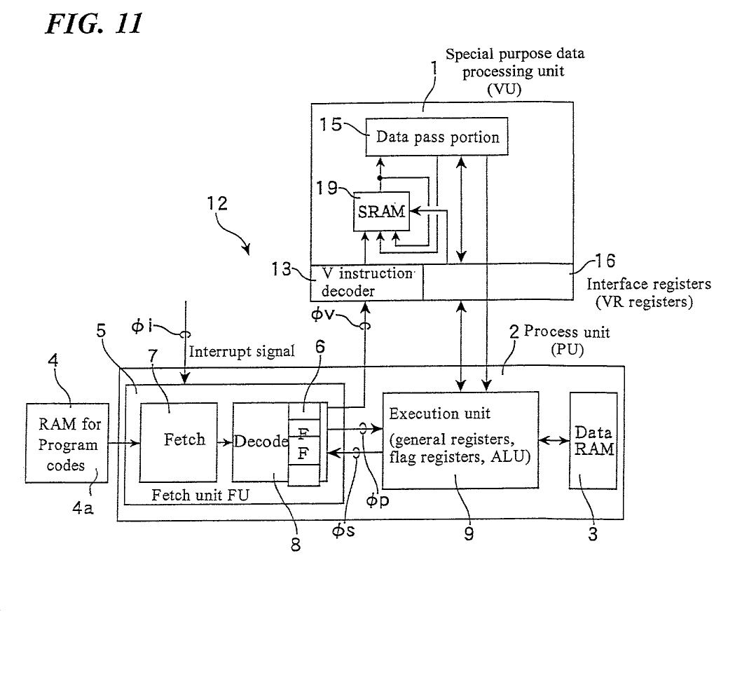

FIG. 11 shows another example of the data processing system according to the invention. As is the case with the aforementioned, the data processing system of this embodiment is a system LSI 12 that is also provided with a PU 2 and a VU 1. Therefore, components in common with the aforementioned LSI 10 and/or 11 will be denoted by the same reference symbols and that description thereof will be omitted. The VU 1 of the LSI 12 employs an SRAM 19 as a sequence control portion of the data path portion 15. If a signal obtained by decoding the V-instruction φv is inputted to the SRAM 19 as a trigger signal, a series of control signals φc3 stored in the SRAM 19 are sequentially supplied to the data path portion 15 so that processings are executed in accordance with a predetermined processing procedure. Thus, in the LSI 12 of this example, the processing procedure in the data path portion 15 can be changed by rewriting the contents of the SRAM 19.

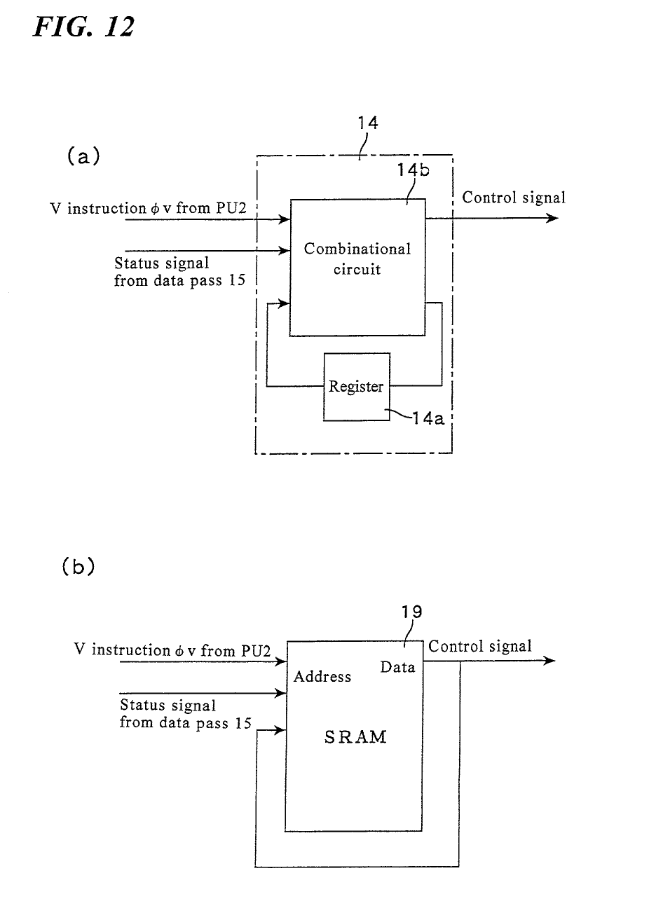

FIG. 12 shows the sequence control portion of the VU 1. FIG. 12(a) shows architecture of the hardware sequence control method based on the FSM 14 shown in FIG. 2, which is composed of the state register 14a and the combinational circuit 14b. In this case, transition occurs fixedly among a limited number of states. Thus, the control signals φc2 are supplied from the PU 2 while bypassing the FSM 14, whereby processings executed in the VU 1 are made reconfigurable. Since control using the FSM 14 is based on hardware, a high processing speed associated with a reduced overhead and a small circuit size can be achieved. Therefore, it is possible to provide a highly compact system LSI suited for real-time processings.

On the other hand, if an attempt is made to control the data path circuit 15 in accordance with a processing procedure other than the one preset in the FSM 14, the invention can provide a method as mentioned above, which makes it possible to flexibly deal with processings other than those set in the FSM 14. However, since the control instruction φc2 is supplied from the PU 2 while bypassing the FSM 14, the processing speed decreases if an attempt is made to execute data processings other than those set in the FSM 14.

FIG. 12 (b) shows architecture of the software sequencer control method in that the SRAM 19 is used. In the software sequencer method, since the contents of the SRAM 19 can be rewritten, the processing speed does not decrease even if the data path portion 15 is controlled in accordance with a processing procedure different from a preset processing procedure by rewritten the contents in the SRAM 19. However, in the sequence controller using the SRAM 19 adopts a method wherein part of control signals output from the SRAM 19 become the state of FSM and fed back as part of input addresses of the SRAM 19 for outputting next control signals. Thus, this method has an increased overhead with respect to the FSM in terms of hardware as well as processing time. This causes an increase in occupied area. Also, the processing speed is reduced in comparison with the FSM.

In the case where the SRAM 19 is employed as a sequence portion, there are two methods of realizing reconfigurable constructions. In one of the methods, PU 2 rewrites the internal data of the SRAM 19. Since the internal data has subsequent addresses that indicate the destinations of transition, by rewriting the address, it is possible to change the order and condition of the sequence. Therefore, if the contents corresponding the predetermined addresses in the SRAM 19 are replaced by downloading from the PU 2, the sequence of the data path 15 is changed. The contents to be downloaded onto the SRAM 19 can be stored in the data RAM 3 of the PU 2 or the like. Also, the other address area of the code RAM 4 or SRAM 19 itself may also be employed for the code area for controlling the data path 15 in a different sequence. Furthermore, if the SRAM 19 is of a two-port read type, rewriting is made possible during execution.

In the other method, the sequencer programs in the SRAM 19 are rewritten at a time. By rewriting the all of SRAM 19 or a unit of control block at a time, the programs to be replaced are not so specialized for replacing and are made more flexibly.

In both method, the program to be downloaded onto the SRAM 19 can be loaded onto the SRAM 19 via an interface register 15 of the VU 1 from the data RAM 3 and the like, according to the P-instruction. Thus, also in the system LSI 12 in which the SRAM 19 is used as the sequence control portion of the VU 1, the processing procedure in the data path portion 15 of the VU 1 can be changed by P-instructions. By changing the programs to be downloaded onto the SRAM 19, it becomes possible to highly flexibly change the processing contents of the VU 1 and flexibly deal with alterations in specification at any stage.

The aforementioned system LSI according to the invention can flexibly deal with even such alterations as have an influence on the processes or specification of the VU 1, and flexibly deal with alterations in specification at any stage of development. Furthermore, it is possible to make the most of the functions of the VU without restricting them to a single function. Further, while remaining characteristics of executing processings by hardware sequence control in the VU 1 at a high speed, the system LSI of the invention can alter the processes of the VU 1 or flexibly execute other processes in the VU 1 by introducing program control to the data path 15 in the VU 1. Therefore, it is possible to provide a system that not only has the aforementioned merits of the system LSI composed of the VU and the PU (VUPU architecture), i.e. real-time processing performance and high-speed processing performance but also deals with alterations and/or modification in specification and so on more flexibly.

The present invention is not limited to the above-described embodiments. It is also possible to provide the mode register MR and the selector capable of selecting the control signals from the SRAM as the sequencer or the control signals obtained by decoding P-instructions. In this system LSI, the sequencer using SRAM replaces the FSM in FIG. 2.

In the above system LSI 11, the V-instruction decoding unit 13 performs the function of decoding P-instructions into the control instructions φc2 of the data path portion 15. However, the location of the unit having the function of conversion into control signals is not limited. For instance, the execution unit 9 of the PU 2 may generate the control instruction φc2. These modifications are also within the scope of the invention.

As described above, according to the invention, in order to solve the problem of making the VU more flexible, the control method that unites high-speed performance of hardware sequence control with flexibility and modifiability of program control is adopted for controlling the VU. In recent years, the field of device designing has been increasingly adopting a designing method comprising the steps of constructing a prototype device using a field programmable gate alley (FPGA which is an LSI whose logic is rewritable on an installed apparatus), verifying the validity of LSI designing by the FPGA, and turning the function of the FPGA into an ASIC. For devices actually produced, ASIC's are employed instead of FPGA's. This is because ASIC's are less expensive in the case of mass-production.

In the case where it is necessary to verify performance of a prototype device employing an FPGA as regards applications requiring real-time processings and high-speed performance and so on, the required performance may not be achieved if the program control method is adopted. This is because the FPGA operates still at a low speed despite the fact that the operating speed thereof has been increasing in recent years. Accordingly, in some cases, the prototype device using FPGA is controlled in the hardware sequence control method. As long as the prototype device employs FPGA, it is possible, because of the features of the FPGA, to change control after construction of the device even if the hardware sequence control method has been adopted. In this case, however, there remains a problem in that control cannot be changed once the function of the FPGA has been turned into that of the ASIC. To the contrary, if it has become possible to perform operation at a higher speed in comparison with the FPGA by turning the function of the FPGA into that of the ASIC, the ASIC itself can meet the required performance even if the program control method is adopted. However, there remains a problem in that operation of the program of the prototype device employing the FPGA cannot be verified at the same speed as in the case of the actually produced device.

When the architecture of the data processing system of the invention is adopted on the above case, hardware sequence control is selected in the prototype device employing FPGA, whereby operation of the prototype device can be verified at the same speed as in the case of an actually produced device. If it becomes necessary to change control after the function of the FPGA has been turned into that of the ASIC, program control can be selectable. Changes in the program create a possibility of dealing with changes in control. Thus, a system LSI (ASIC) to which the data control device of the invention has been applied matches the circumstances of development which are based on a prototype device employing FPGA. This system is particularly suited for an ASIC for uses requiring high-speed performance and real-time process ability such as image processings and network processings.

As described above, according to the invention, the PU that is the general-purpose data processing unit can control the dedicated circuit of the VU that is the special purpose data processing unit in accordance with a processing procedure different from the predetermined processing procedure set in the VU in advance. Thus, while maintaining high-speed performance and real-time processability of the VU, the dedicated circuit of VU becomes flexibly controlled by the PU. Thus, it is possible to provide the data processing system that has VU and PU and that can flexibly deal with such alterations as have an influence on the specification of the VU. Moreover, since the dedicated circuit can be controlled in accordance with a processing procedure other than the predetermined processing procedure set in the VU in advance, it is possible to provide the data processing device that can make the most of the function of the VU.

What is claimed is:

1. A data processing system comprising:
at least one special purpose data processing unit for executing a series of predetermined data processes by a special purpose instruction; and
a general purpose data processing unit for executing processes designated by general purpose instructions,
wherein the special purpose data processing unit has a dedicated circuit portion specialized in specific data processes and a sequence control portion that supplies the dedicated circuit portion with control signals to control the dedicated circuit portion in accordance with a predetermined processing procedure, and
wherein the general purpose data processing unit is able to control the dedicated circuit portion in accordance with a procedure different from the processing procedure preset in the sequence control portion.

2. A data processing system according to claim 1,
wherein the general purpose data processing unit is able to supply the dedicated circuit portion with control signals superseding the control signals supplied from the sequence control portion, and
wherein the special purpose data processing unit has a selection means for supplying the dedicated circuit portion with selected control signals among the control signals supplied from the sequence control portion and the control signals supplied from the general purpose data processing unit.

3. A data processing system according to claim 1,
wherein the general purpose data processing unit is able to change the processing procedure set in the sequence control portion.

4. A data processing system according to claim 1, further comprising:
a fetch unit for fetching the special purpose instruction and the general purpose instructions from a recording means where a program having the special purpose instruction and the general purpose instructions are recorded and for supplying the special purpose data processing unit with the special purpose instruction.

5. A data processing system according to claim 4,
wherein the general purpose data processing unit is able to supply the dedicated circuit portion with control signals superseding the control signals supplied from the sequence control portion based on at least one of the general purpose instructions, and
wherein the special purpose data processing unit has a selection means for supplying the dedicated circuit portion with selected control signals among the control signals supplied from the sequence control portion and the control signals supplied from the general purpose data processing unit.

6. A data processing system according to claim 5,
wherein the selection means is controlled by the general purpose data processing unit.

7. A data processing system according to claim 4,
wherein the general purpose data processing unit changes the processing procedure set in the sequence control portion according to at least one of the general purpose instructions.

8. A control method of a data processing system comprising at least one special data processing unit for executing a series of predetermined data processes by a special purpose instruction and a general purpose data processing unit for executing processes designated by general purpose instructions, wherein the special purpose data processing unit has a dedicated circuit portion specialized in specific data processings and a sequence control portion that supplies the dedicated circuit portion with control signals to control the dedicated circuit portion in accordance with a predetermined processing procedure, comprising:
a first step of supplying the dedicated circuit portion with a series of the control signals by the special purpose instruction in accordance with the processing procedure preset in the sequence control portion and controlling the dedicated circuit portion; and
a second step of controlling the dedicated circuit portion by at least one of the general purpose instructions in accordance with a procedure different from the processing procedure preset in the sequence control portion.

9. A control method according to claim 8,
wherein, in the second step, control signals superseding the control signals of the sequence control portion are supplied to the dedicated circuit portion based on at least one of the general purpose instructions.

10. A control method according to claim 8,
wherein, in the second step, the processing procedure preset in the sequence control portion is changed.

11. A program product for controlling a data processing system, the program product has general purpose instructions for a general purpose data processing unit and a special purpose instruction for a special purpose data processing unit comprising a dedicated circuit portion specialized in specific data processings and a sequence control portion that supplies the dedicated circuit portion with control signals to control the dedicated circuit portion in accordance with a predetermined processing procedure,
wherein the special purpose instruction is an instruction to supply the dedicated circuit portion with control signals in accordance with a preset processing procedure in the sequence control portion and to control the dedicated circuit portion, and
wherein, as the general-purpose instructions, a priority instruction to control the dedicated circuit portion in accordance with a procedure different from the processing procedure preset in the sequence control portion is provided.

12. A program product according to claim 11,
wherein the priority instruction is an instruction that is converted into control signal superseding the control signals supplied from the sequence control portion and that is then supplied to the dedicated circuit portion.

13. A program product according to claim 11,
wherein the priority instruction is an instruction to change the processing procedure preset in the sequence control portion.
